(19) United States
(12) Patent Application Publication
(10) Pub. No.: US 2011/0144784 A1
(43) Pub. Date: Jun. 16, 2011

(54) SYSTEM AND METHOD FOR EMBEDDING AND USING INTELLIGENT PRODUCT MANUFACTURING INFORMATION STORED IN CAD MODEL OBJECTS

(75) Inventors: Edwin Gasparraj, Mason, OH (US); Andrew Koilpillai, Northville, MI (US)

(73) Assignee: Siemens Product Lifecycle Management Software Inc., Plano, TX (US)

(21) Appl. No.: 12/636,391

(22) Filed: Dec. 11, 2009

(51) Int. Cl. G05B 19/4097; G06F 17/50

(52) U.S. Cl. 700/98; 700/107; 700/182

(57) ABSTRACT

A method and corresponding CAD system and computer-readable medium. The method includes receiving a part definition for a first part model, the part definition including intelligent part manufacturing information (IPMI) data that defines requirements for at least one second part model in an assembly model. The method also includes placing the first part model in the assembly model. The method also includes processing the IPMI data, including transferring at least one requirement from the first part model to the second part model. The method can also include loading the IMPI from the second part model, wherein the IPMI loaded from the second part model is used for manufacturing a physical part corresponding to the second part model.

### TECHNICAL FIELD

The present disclosure is directed, in general, to systems and methods for computer-aided design, manufacturing, engineering, modeling, and visualization (individually and collectively, “CAD” and “CAD systems”).

### BACKGROUND OF THE DISCLOSURE

Many manufactured products are first designed and modeled in CAD systems. Improved systems are desirable.

### SUMMARY OF THE DISCLOSURE

Various embodiments include a method and corresponding CAD system and computer-readable medium. In some embodiments, the method includes receiving a part definition for a first part model, the part definition including intelligent part manufacturing information (IPMI) data that defines requirements for at least one second part model in an assembly model. The method also includes placing the first part model in the assembly model. The method also includes processing the IPMI data, including transferring at least one requirement from the first part model to the second part model. The method can also include loading the IMPI from the second part model, wherein the IPMI loaded from the second part model is used for manufacturing a physical part corresponding to the second part model.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented, for example as a CAD system as described herein;

FIG. 2 depicts a flowchart of a conventional design and manufacturing process using a simple example;

FIG. 3 illustrates a simple example of a part in accordance with disclosed embodiments;

FIG. 4 depicts a flowchart of a process in accordance with disclosed embodiments; and

FIG. 5 illustrates an example of IMPI data transferred to a second part, and usable for downstream applications, in accordance with disclosed embodiments.

### DETAILED DESCRIPTION

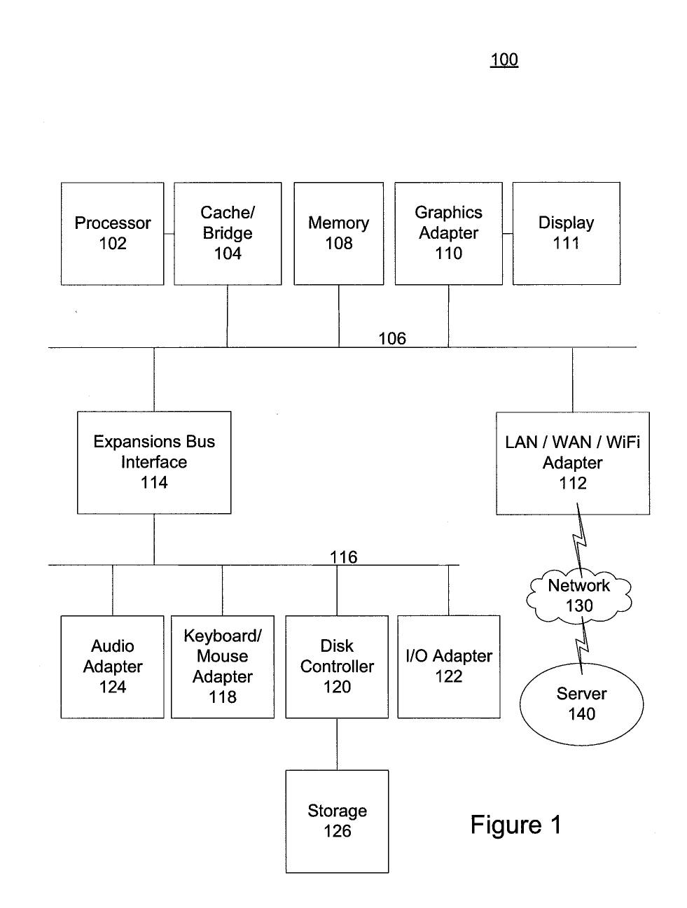

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Today, in design and manufacturing engineers' workflow, more than half of the time is spent modeling and manufacturing details that deal with standard parts. These standard parts are repeated within each assembly and between different product assemblies.

Typically, mathematical surface data is the only medium of data transfer between the designers and the manufacturing engineers. A wealth of downstream application data is repeatedly and manually created in order to effectively use that surface data. The embodiments disclosed herein include systems and methods for more intelligent use of CAD part data.

Embodiments described herein include a system and method for designing reusable standard CAD parts with embedded manufacturing information, automatically transferring this to adjacent parts in an assembly and using this information in downstream applications such as CAM.

FIG. 1 depicts a block diagram of a data processing system in which an embodiment can be implemented, for example as a CAD system as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

In a typical product design and manufacturing workflow, product designers and definition engineers use CAD systems to design the entire assembly. Most of the parts in any given assembly are industry standard or local standard parts. These parts are usually saved in reuse libraries and are simply referenced in the assembly.

A significant portion of the designers' time is spent modeling the intersecting features in structural components of the assembly where these standard parts fit in.

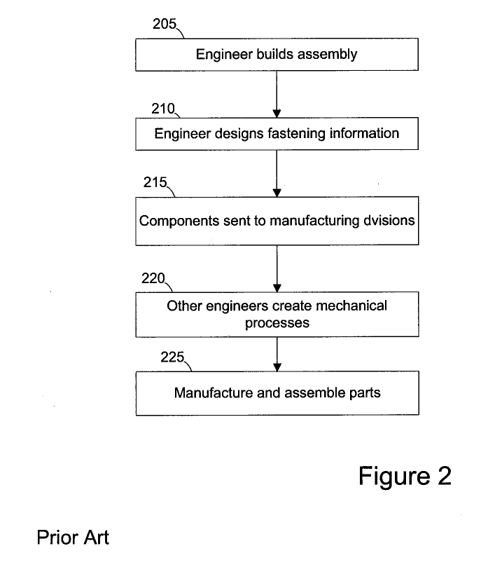

FIG. 2 depicts a flowchart of a conventional design and manufacturing process. In such a process, using a CAD system, an engineer builds an assembly that typically includes many standard parts (step 205).

Next, the engineer is typically required to design all information that describes how each part is attached or fastened to each other part (step 210). This can include holes, pads, pockets, and other features that must be present in the assembly to properly join the various parts of the assembly.

The individual structural components in the assembly are then sent to manufacturing divisions (step 215). Here manufacturing engineers and numerically-controlled (NC) machine programmers must create all the mechanical processes to machine the part (step 220). Typically, as part of this process, these persons must manually analyze the part, identify features that need to be machined, select cutting tools, machines and processes for each. CAD systems are used to create NC tool path data for the machine tools. In a typical machinery or mold/die part, more than half of the machining happens on features that receive standard parts. Feature based machining techniques are available to automate this process. CAD geometry is used to do feature recognition. However, the reliability of these systems goes down as the complexity of intersecting features increases. Most of the manufacturing information available with standard parts is never captured and passed down to NC programmers.

Finally, the parts can be manufactured and assembled (step 225).

In such a process, a significant portion of the manufacturing engineers' time is spent on analyzing CAD data and creating processes. CAD surface data is treated as the primary medium to transfer information from design to manufacturing. Industry standard product manufacturing information (PMI) is sometimes used to simply indicate features such as threads.

Often, more than half of the development time is spent modeling and manufacturing details that deal with standard parts. These standard parts are repeated within each assembly and between different product assemblies. In conventional systems, mathematical surface data is the only medium of data transfer between the designers and the manufacturing engineers. The great majority of downstream application data is repeatedly and manually created.

Disclosed embodiments include systems and methods that capture and reuse downstream manufacturing information in standard parts. Downstream application engineers collaborate with design engineers and store information in standard parts. A “standard” part as used herein refers to CAD parts that may be reused in various assemblies, and that are structured and operable as described herein, not to conventional CAD parts that may be used by prior art systems. This data structure is referred to herein as Intelligent Product Manufacturing Information (IPMI). Design engineers or other users can model and store all the intersecting ‘cut’ features in the standard part.

The disclosed IPMI can function as an open data structure where users can name and organize data such as names, numbers, referenced geometric entities such as sections, vector, and application entities such as cutting tool definitions and tool path, as well as other information that can be used in the modeling and manufacture of assemblies.

When a standard part is placed in the assembly, the cut features or other IPMI information saved in standard parts are used to create Boolean (or other) operations in the receiving component. The entire IPMI is transferred to the receiving feature, which can include any other feature or component in the assembly for which the IPMI includes information. The system can also be configured to reference the original IPMI data for associative updates.

Disclosed embodiments allow true integration between the design and manufacturing aspects in the ability to pass on manufacturing intent along with mathematical solid models. The industry standard PMI are still restricted to final part standard such as surface finish, tolerance and thread data, while the disclosed IPMI techniques enable true manufacturing information transfer in a flexible mechanism. The embodiments disclosed herein can be used, for example for including machining access vector for machining a feature, process requirements for a thread, inspection points on a surface, cutting tool required to finish a particular feature, heat treatment requirements for a part, etc.

The disclosed IPMI structure allows users to define this manufacturing information packet and pass it on to downstream applications. In various embodiments, the disclosed IPMI includes an open data structure where users can name and organize data such as names, numbers, referenced geometric entities such as sections, vector, and application entities such as cutting tool definitions and tool paths.

Further, in various embodiments, certain levels of assembly level modeling work can be automated by defining ‘cut’ features in the standard parts and using these in assembly context.

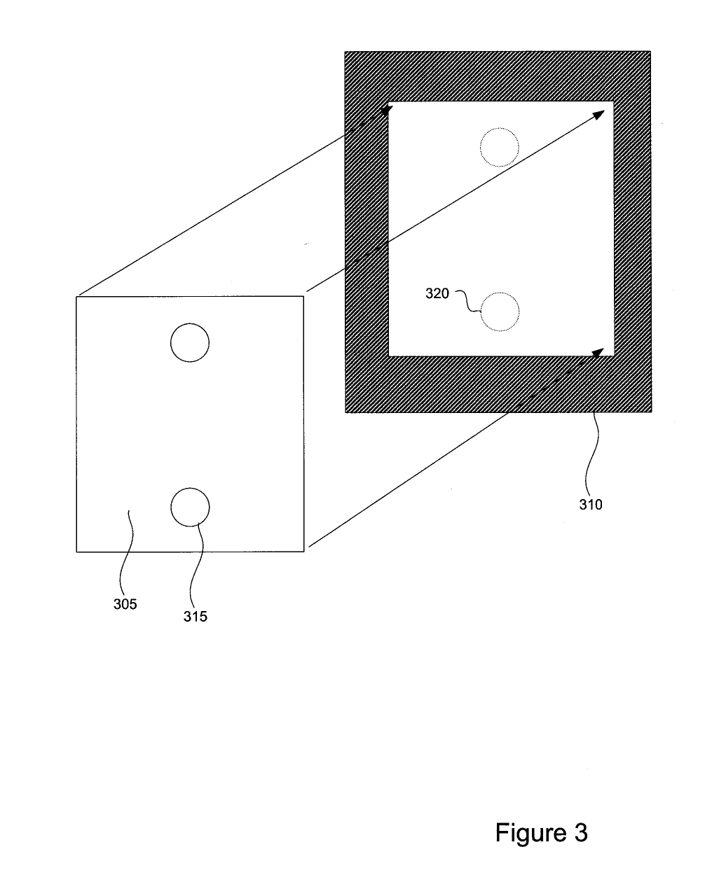

FIG. 3 illustrates a simple example of a part in accordance with disclosed embodiments, including IPMI. In this figure, assume that plate part 305 is to be mounted as shown in an assembly, adjacent to part 310. Plate part 305 includes two mounting hole feature 315, and requires corresponding mounting holes 320 in part 310. The IPMI included with plate part 305 could include, for example, a definition of the mounting holes 320, the threading required for holes 320, specifications for the screws required to mount plate part 305 to part 310 using holes 315 and 320, the materials required for plate part 305, the cost of the materials or the screws, particular machining requirements for plate part 305, holes 315, or holes 320, tool paths for machining any of these parts, or other similar information.

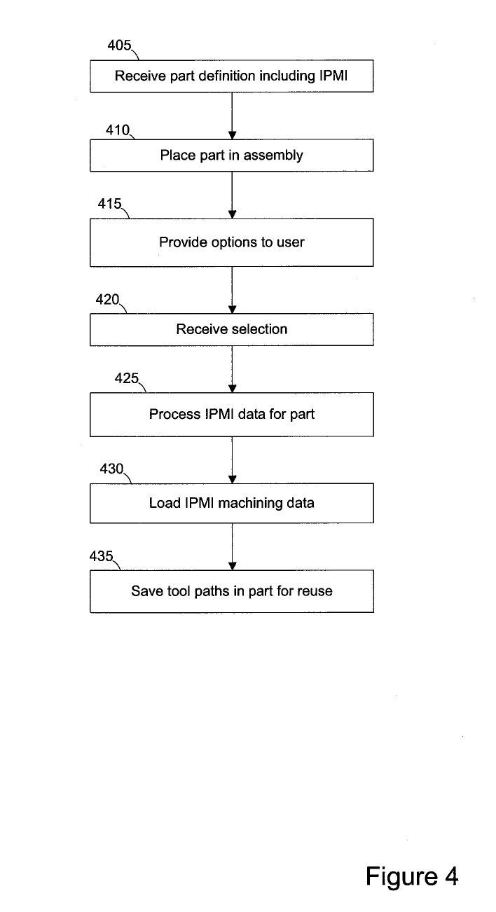

FIG. 4 depicts a flowchart of a process in accordance with disclosed embodiments.

The system receives a part definition including IPMI data for a part model to be placed in an assembly model (step 405). Receiving, in this context, can include an interaction with a user to design a part definition, receiving the part definition from another system, or loading the part definition form a standard parts library. In some embodiments, certainly, the system can maintain a standard parts library with parts definitions including “transferable manufacturing” information and other information as IPMI data, including information that defines requirements for other part models in the assembly. IPMI data can include, but is not limited to
Interacting Cut Features. For example, an O-ring can contain information about the circular slots in the two adjoining components.
Machining Attributes. For example, positioning a wear-plate in an assembly can transfer product attributes to the mating face.
PMI. For example, a wear plate can contain information about the fasteners needed to mount it without carrying fastener geometry.
Other geometry such as sections and axis. For example, this can include the part's pierce punch base pocket section and direction.
Other manufacturing information such as cutting tools and tool path.

The system places the part in an assembly (step 410). This can be performed in response to an instruction received from a user, received from another system, performed as part of an automated process, or otherwise. For example, a designer or engineer may indicate the location where the part is placed in the assembly.

When the standard components are positioned in an assembly, the system can provide options to a user to transfer some or all of the IPMI data discussed above (step 415). This can include displaying, to the user, the IPMI for the part that is available to be transferred to other parts of the assembly.

The system receives a corresponding selection (step 420). Of course, other embodiments provide that all IPMI information is automatically transferred to the appropriate parts in the assembly, so that steps 415 and 420 are skipped.

In various embodiments, and according to any selection received above, the system processes the IPMI data for the part, including transferring at least some of the IPMI data to a second part (step 425). Processing can also include performing automatic Boolean operations using cut features, transferring attributes, PMIs, geometry, and tools to the appropriate receiving body or other part in the assembly (typically an adjacent part), and performing other functions as described herein. In some embodiments, this includes the system automatically creating any intersecting features in the assembly (such as a hole in both the added part and an adjacent part for a fastener such as a bolt).

When each component is ready for machining, the system can automatically load all transferred IPMI data, including attributes, PMI, sections, tool axis, etc. (step 430).

The system can then assign machining processes to these features (step 435). This can include the system automatically extracting or generating machining processes and tool path data from the IPMI data. Note that steps 430 and 435 are similar for any downstream process, application, or system that can load transferred IPMI data and use it for further processing, whether in a computer-aided manufacturing (CAM) process or otherwise.

In some embodiments, the system can also save manufacturing tool paths in the standard part and reuse them (step 440).

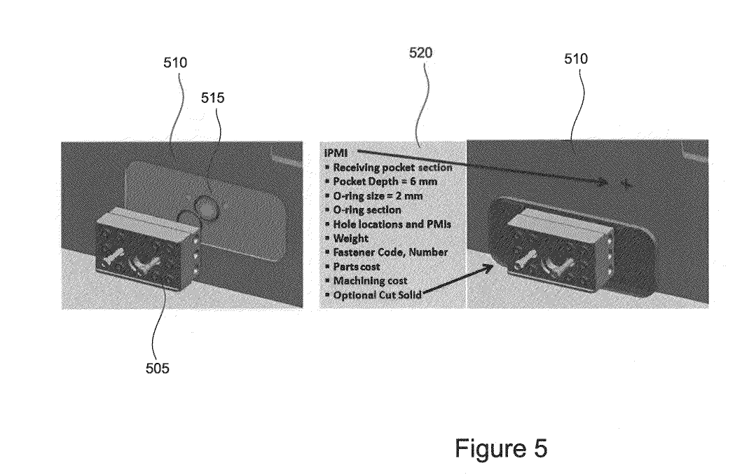

FIG. 5 illustrates an example of IMPI data transferred to a second part, and usable for downstream applications. In this example, first part 505 will be attached to a second part 510 in the assembly. As shown at pocket section 515, first part 505 requires several features to be machined into second part 510 for proper attachment, including the receiving pocket section 515, various mounting holes, and an o-ring section. IPMI 520 is stores as part of the first part 505, and includes such data as the receiving pocket section definition, receiving pocket depth, the o-ring size, the o-ring section and other definitions, hole locations and other PMI, the weight of first part 505, fastener codes and numbers to attach first part 505, parts cost information, and machining cost information, though of course more or less information is included.

When the system has received a selection of the first and second parts, as described above, the IPMI of the first part 505 is processed and transferred to the second part 310, as shown on the right of FIG. 5. Thereafter, downstream processes or systems can use the IPMI 520, originally from the first part 505 and now also stored in the second part 510, for further processing of the second part. This can include, but is not limited to, a downstream CAM system using the IPMI to properly machine the second part 510.

Note that while the “system” is described in singular for above, the CAD system can also be implemented by multiple data processing systems, each performing one or more of the steps described herein, and “system” or “CAD system” should be understood to include multiple data processing systems that together perform the described processes, are configured to perform the described processes, or execute instructions to perform the described processes.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for use in a CAD system, comprising:
receiving a part definition for a first part model in a CAD system, the part definition including intelligent part manufacturing information (IPMI) data that defines requirements for at least one second part model in an assembly model;
placing the first part model in the assembly model in the CAD system;
processing the IPMI data by the CAD system, including transferring at least one requirement from the first part model to the second part model.

2. The method of claim 1, further comprising presenting a user a selection of, requirements to be transferred to the second part model.

3. The method of claim 1, further comprising receiving a selection of requirements to be transferred to the second part model.

4. The method of claim 1, wherein the IPMI data includes interacting cut features between the first part model and the second part model.

5. The method of claim 1, wherein the IPMI data includes machining attributes.

6. The method of claim 1, wherein the IPMI data includes additional geometry data related to the first part.

7. The method of claim 1, wherein the IPMI data includes manufacturing tool path information.

8. The method of claim 1, further comprising loading the IMPI from the second part model, wherein the IPMI loaded from the second part model is used for manufacturing a physical part corresponding to the second part model.

9. A CAD system comprising at least one data processing system having a processor and accessible memory, the CAD system configured to perform the steps of:
receiving a part definition for a first part model, the part definition including intelligent part manufacturing information (IPMI) data that defines requirements for at least one second part model in an assembly model;
placing the first part model in the assembly model;
processing the IPMI data, including transferring at least one requirement from the first part model to the second part model.

10. The CAD system of claim 9, further configured to present a user a selection of requirements to be transferred to the second part model.

11. The CAD system of claim 9, further configured to receive a selection of requirements to be transferred to the second part model.

12. The CAD system of claim 9, wherein the IPMI data includes interacting cut features between the first part model and the second part model.

13. The CAD system of claim 9, wherein the IPMI data includes machining attributes.

14. The CAD system of claim 9, wherein the IPMI data includes additional geometry data related to the first part.

15. The CAD system of claim 9, wherein the IPMI data includes manufacturing tool path information.

16. The CAD system of claim 9, further configured to load the IMPI from the second part model, wherein the IPMI loaded from the second part model is used for manufacturing a physical part corresponding to the second part model.

17. A computer-readable medium encoded with computer-executable instructions that, when executed, cause a CAD system to perform the steps of:
receiving a part definition for a first part model, the part definition including intelligent part manufacturing information (IPMI) data that defines requirements for at least one second part model in an assembly model;
placing the first part model in the assembly model;
processing the IPMI data, including transferring at least one requirement from the first part model to the second part model.

18. The computer readable medium of claim 17, further encoded with instructions for presenting a user a selection of requirements to be transferred to the second part model.

19. The computer readable medium of claim 17, further encoded with instructions for receiving a selection of requirements to be transferred to the second part model.

20. The computer readable medium of claim 17, wherein the IPMI data includes interacting cut features between the first part model and the second part model.

21. The computer readable medium of claim 17, wherein the IPMI data includes machining attributes.

22. The computer readable medium of claim 17, wherein the IPMI data includes additional geometry data related to the first part.

23. The computer readable medium of claim 17, wherein the IPMI data includes manufacturing tool path information.

24. The computer readable medium of claim 17, further encoded with instructions for loading the IMPI from the second part model, wherein the IPMI loaded from the second part model is used for manufacturing a physical part corresponding to the second part model
